(19) United States
(12) Patent Application Publication
(10) Pub. No.: US 2020/0117756 A1
(43) Pub. Date: Apr. 16, 2020

(54) REST APPLICATION PROGRAMMING INTERFACE PARADIGMS FOR BIG DATA ANALYTICS

(71) Applicant: CA, Inc., New York, NY (US)

(72) Inventors: ANILA KUMAR GARIMELLA, MILPITAS, CA (US); KRUSHNA BAGDE, SUNNYVALE, CA (US)

(21) Appl. No.: 16/157,665

(22) Filed: Oct. 11, 2018

(51) Int. Cl. G06F 17/30; H04L 29/08; G06F 9/54; G06N 99/00

(52) U.S. Cl. CPC G06F 17/30864; H04L 67/02; G06N 99/005; G06F 17/30569; G06F 9/547

(57) ABSTRACT

Embodiments of the present disclosure provide a query paradigm that enables named function chaining and nesting to create complex query structures for advanced data analytics. Initially, a REST request uniform resource identifier (URI) is received from a REST client or Hypertext Transfer Protocol (HTTP) client at a REST API. The REST query URI comprises a syntax of functions with named parameters as URI path segments over a HTTP GET call and forms a function tree. The REST request URI is communicated to a request parser that converts the REST request URI into a backend query. The backend query normalizes the function tree into a normalized tree in accordance with a structure of a target of the REST request URI. The backend query is utilized to query data form the target of the REST request URI. Data responsive to the backend query is provided to the REST client or HTTP client.

### BACKGROUND

As organizations embrace offering cloud and mobile services, many challenges are encountered. For example, providing interoperability between computers systems on the Internet is increasingly important. Accordingly, many data storage solutions have utilized an architectural style known as Representation State Transfer (REST) to create REST application programming interfaces (APIs). Although REST APIs can provide the desired interoperability between computer systems on the Internet, the use of REST APIs is not as intuitive as structured query language (SQL) and often introduces REST anti-patterns (e.g., HTTP POST tunneling). Further, composing some queries in formats like JavaScript Object Notation (JSON) in a POST body is cumbersome, unintuitive, and difficult to construct. Moreover, securing resources for REST APIs requires insight into the body of the HTTP message to understand the context of the API.

### SUMMARY

This summary is provided to introduce a selection of concepts in a simplified form that are further described below in the detailed description. This summary is not intended to identify key features or essential features of the claimed subject matter, nor should it be used as an aid in determining the scope of the claimed subject matter.

Embodiments of the present disclosure relate to query paradigms. More particularly embodiments of the present disclosure relate to a query paradigm that enables named function chaining and nesting to create complex query structures for advanced data analytics. Initially, a REST request uniform resource identifier (URI) is received from a REST client or a Hypertext Transfer Protocol (HTTP) client at a REST API. The REST query URI comprises a syntax of functions with named parameters as URI path segments over a HTTP GET call and forms a function tree. The REST request URI is communicated to a request parser that converts the REST request URI into a backend query. The backend query normalizes the function tree into a normalized tree in accordance with a structure of a target of the REST request URI. The backend query is utilized to query data form the target of the REST request URI. Data responsive to the backend query is provided to the REST client or the HTTP client.

### BRIEF DESCRIPTION OF THE DRAWINGS

The present invention is described in detail below with reference to the attached drawing figures, wherein:

FIG. 1 is a block diagram showing a system that provides REST API paradigms for big data analytics, in accordance with an embodiment of the present disclosure;

FIG. 2 is a block diagram showing a flow of communication between components of an exemplary query system, in accordance with embodiments of the present disclosure;

FIG. 3 is a flow diagram showing a method of providing data responsive to a converted REST request URI, in accordance with embodiments of the present disclosure;

FIG. 4 is a flow diagram showing a method of converting a REST request URI into a backend query, in accordance with embodiments of the present disclosure; and

FIG. 5 is a block diagram of an exemplary computing environment suitable for use in implementing embodiments of the present disclosure.

### DETAILED DESCRIPTION

The subject matter of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. As used herein, the singular forms “a,” “an,” and “the” are intended to include the plural forms as well, unless the context clearly indicates otherwise.

As noted in the background, many challenges are encountered as organizations embrace offering cloud and mobile services. For example, providing interoperability between computers systems on the Internet is increasingly important. Accordingly, many data storage solutions have utilized an architectural style known as Representation State Transfer (REST) to create REST application programming interfaces (APIs). Although REST APIs can provide the desired interoperability between computer systems on the Internet, the use of REST APIs is not as intuitive as structured query language (SQL) and often introduces REST anti-patterns (e.g., HTTP POST tunneling). Further, composing some queries (JavaScript Object Notation (JSON) queries) in a POST body is cumbersome and difficult to learn. Moreover, securing resources for REST APIs requires insight into the body of the HTTP message to understand the context of the API. In big data analytics, there is not current platform that provides a query paradigm that uses named parameter function trees as building blocks to solve big data analytics use cases.

Embodiments of the present disclosure relate to query paradigms. More particularly embodiments of the present disclosure relate to a query paradigm that enables named function chaining and nesting to create complex query structures for advanced data analytics. Initially, a REST request uniform resource identifier (URI) is received from a REST client or a Hypertext Transfer Protocol (HTTP) client at a REST API. The REST query URI comprises a syntax of functions with named parameters as URI path segments over a HTTP GET call and forms a function tree. The REST request URI is communicated to a request parser that converts the REST request URI into a backend query. The backend query normalizes the function tree into a normalized tree in accordance with a structure of a target of the REST request URI. The backend query is utilized to query data form the target of the REST request URI. Data responsive to the backend query is provided to the REST client or the HTTP client.

In embodiments, the present disclosure enables an analytics platform to provide a powerful and intuitive query paradigm without introducing REST anti-patterns. Generally speaking, search queries do not change the state of the system; rather, they are ideally built on GET semantics. Basic search queries may comprise resource type selection, filtering, sorting, and pagination criteria. In the analytics space, search queries need to be more sophisticated so they can support query trees (e.g., “group by first name,” “sub group by last name,” or “date of birth”).

As can be appreciated, such composite queries may be viewed as SQL-like queries (e.g., nested “GROUP BY” clauses with a “WHERE” clause providing the basic premise for a selection of records on which grouping needs to be done). The key difference is that a SQL “GROUP BY” clause is always value based. However, in big data analytics, grouping requirements may be based on value, time interval, numeric range, geographical range, or some other specific criteria. Moreover, in advanced analytics, use cases often involve data science and grouping may be an outcome of an algorithm (e.g., linear regression or k-means clustering) which may be provided by machine learning libraries. Accordingly, the present disclosure enables a RESTful query API that enables users to build a function tree by applying the syntax of named parameters over HTTP GET calls.

In embodiments, the present disclosures enables security rules to be defined at the target of the query such that only queries of targets that users have access to will result in responses to the queries. Moreover, it is much less expensive computationally to secure via HTTP gateways and filters. In some embodiments, data analytics and machine learning algorithms and capabilities can be exposed as web services over REST APIs enabling analytics and machine learning as a service.

Accordingly, one embodiment of the present disclosure is directed to a method. The method comprises receiving a Representational State Transfer (REST) request Uniform Resource Identifier (URI) from a REST client or a Hypertext Transfer Protocol (HTTP) client at a REST application programming interface (API). The REST request URI comprises a syntax of functions with named parameters as URI path segments over a HTTP GET call and forms a function tree. The method also comprises communicating the REST request URI to a request parser. The request parser converts the REST request URI into a backend query. The backend query normalizes the function tree into a normalized tree in accordance with a structure of a target of the REST request URI. The method further comprises utilizing the backend query, querying data from the target of the REST request URI. The method also comprises providing the data responsive to the backend query to the REST client or the HTTP client.

In another embodiment, the present disclosure is directed to a computer storage medium storing computer-useable instructions that, when used by at least one computing device, cause the at least one computing device to perform operations. The operations comprise receiving, at a request parser, a Uniform Resource Identifier (URI) comprising a syntax of functions with named parameters as URI path segments over a Hypertext Transfer Protocol (HTTP) GET call. The URI is provided by a Representational State Transfer (REST) client or a HTTP client to the request parser via a REST application programming interface (API). The operations also comprise convert the URI, at the request parser, to a backend query corresponding to a structure of a target of the query. The operations further comprise communicating the backend query to the REST API.

In yet another embodiment, the present disclosure is directed to a computerized system. The system includes a processor and a computer storage medium storing computer-useable instructions that, when used by the processor, cause the processor to receive, at a request parser, a request comprising a syntax of functions with named parameters as path segments over a Hypertext Transfer Protocol (HTTP) GET call provided by a representational state transfer (REST) client or a HTTP client to the request parser via a REST application programming interface (API). The request is converted, at the request parser, to a backend query corresponding to a structure of a target of the query. The target of the request comprises more than one database, wherein a first database of the more than one database is in a different format than a second database of the more than one database. The backend query is communicated to the REST API.

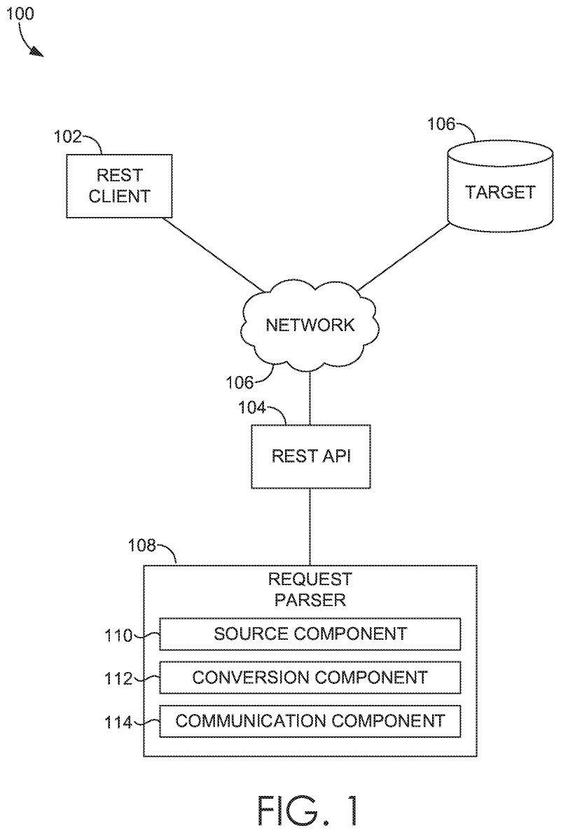

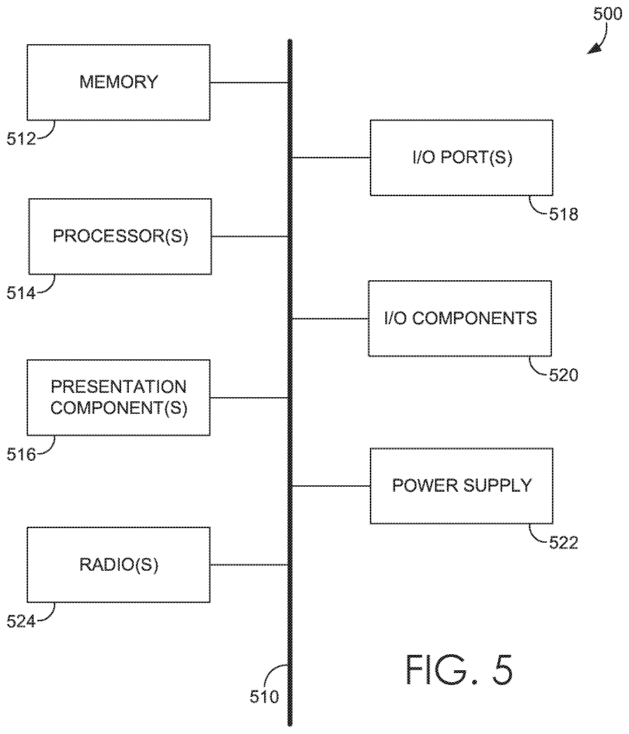

Referring now to FIG. 1, a block diagram is provided that illustrates a query system 100 that provides REST API paradigms for big data analytics, in accordance with an embodiment of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory. The query system 100 may be implemented via any type of computing device, such as computing device 500 described below with reference to FIG. 5, for example. In various embodiments, the query system 100 may be implemented via a single device or multiple devices cooperating in a distributed environment.

The components may communicate with each other via a network 202, which may include, without limitation, one or more local area networks (LANs) and/or wide area networks (WANs). Such networking environments are commonplace in offices, enterprise-wide computer networks, intranets, and the Internet. It should be understood that any number of request parsers may be employed within the query system 100 within the scope of the present disclosure. Each may comprise a single device or multiple devices cooperating in a distributed environment. For instance, the request parser 108 (or any of its components: source component 110, conversion component 112, communication component 114) may be provided via multiple devices arranged in a distributed environment that collectively provide the functionality described herein. In other embodiments, a single device may provide the functionality of multiple components of the query system 100. For example, a single device or entity may provide the request parser 108 and the REST API 104. In this way, a web service may expose both the request parser 108 and the REST API 104. Additionally, other components not shown may also be included within the query system 100.

As noted, the query system 100 generally operates to provide REST API paradigms for big data analytics. As shown in FIG. 1, the query system 100 may include REST client 102, REST API 104, target database 106, and request parser 108. It should be understood that the query system 100 shown in FIG. 1 is an example of one suitable computing system architecture. Each of the components shown in FIG. 1 may be implemented via any type of computing device, such as computing device 500 described with reference to FIG. 5, for example. Additionally, other components not shown may also be included within the environment.

REST API 104 generally provides an interface that enables users via a REST client 102 (or HTTP client) to issues REST queries to one or more databases, such as target database 106. In embodiments, the user may communicate a query via the REST client 102 to the REST API 104. As described herein, the REST query is provided in a technology agnostic format and enables the aggregation of data agnostic to the location of the data responsive to the query. More particularly, the query is in a named function chaining and nesting format that enable the user to create complex query structures for advanced data analytics without introducing REST anti-patterns. Importantly, the REST query may request data from multiple data sources. Moreover, some or all of the multiple data sources may be different formats. For example, the REST query may request data from both relational (e.g., SQL) and non-relational (e.g., NoSQL) sources.

Request parser 108 generally converts queries received from the REST API 104 into backend queries that are usable by the particular target of the query. As mentioned, request parser 108 comprises source component 110, conversion component 112, and communication component 114.

Source component 110 initially receives the REST query. The query may comprise a syntax of functions with named parameters as URI path segments over a HTTP GET call and form a function tree. Exemplary semantics for the REST queries are illustrated in Table 1.

| GET Path | Description | Examples |
|---|---|---|
| /<product_id>/<tenant_id>/<doctype_docversion>/ | Get result(s) | /twitter/ca/tweets/group_by(field=‘hashtag’) |
| <function>(....) | by executing a | /twitter/ca/tweets/avg(field=‘likes’)?_filter=hashtags |
| | function on a | has ‘#ca’ |
| | collection | |
| | resources | |
| /<product_id>/<tenant_id>/<doctype_docversion>/ | Nested | /twitter/ca/tweets/groupby_value(field=‘hashtags’)/ |
| <function>(....)/<sub_function>(...)/... | execution of | avg(field=‘likes’) |
| | functions | |
| | to apply a | |
| | function on | |
| | results | |
| | of previously | |
| | executed | |
| | function | |

In some embodiments, the source component 110 enables users to build a function tree by applying the syntax of named parameters over HTTP GET calls. In such a function tree, sibling function nodes may be comma separated and child function nodes may be represented as path segments following that of parent nodes. For example, sample URL templates are illustrated in Table 2.

TABLE 2
http :// host:port / ResourceSet / Function(param1=value1,...) / ChildFunction(param1=value1...) ? _filter=...
http :// host:port / ResourceSet / Function1(param1=value1,...) , Function2(param1=value1,...) /
ChildFunction(param1=value1) ? _filter=...
http :// host:port / ResourceSet / Function1(param1=value1,...) , Function2(param1=value1,...) /
ChildFunction(param1=value1) / GrandChildFunction(...) ? _filter=...
http :// host:port / ResourceSet / Function1(name=‘f1’, params1=value1,...) , Function2(name=‘f2’,
param1=value1,...) / ChildFunction1(parent=‘f1’, param1=value1) , ChildFunction2(name=‘f2’, param1=value1) ?
_filter=...

In some embodiments, the source component 110 enables special operations (i.e., functions) to be performed on a resource collection or a specific resource. In this way, functions are executed via a GET call and are idempotent. Exemplary grouping functions are illustrated in Table 3.

TABLE 3

| Function Name | Syntax | Description |
|---|---|---|
| groupby_value | /tweets/groupby_value(field=‘tags’) | Group results by value of a specific |
| | | field |
| groupby_timeinterval | /tweets/groupby_timeinterval(field=‘creation_date’, | Group results by time |
| | interval=‘day’, | duration/period |
| | timezone=‘+5:30’) | |
| groupby_interval | /tweets/groupby_interval(field=‘likes’, | Group results by numeric interval |
| | interval=1000) | |
| groupby_daterange | /Alerts/groupby_daterange(field=‘creation_date’, | Group results by date range |
| | range=(2015-01-01, 2016-01-01), range=...) | Optionally, names of each range |
| | | are assigned |
| | | by the prefix ‘name:’ convention. |
| groupby_range | /Tweets/groupby_range(field=‘comment_count’, | Group results by range of values. |
| | normal:range=(,10), | Optionally, names of each range |
| | popular:range=(10,20), very_popular:range=(20,)) | are assigned |
| | | by the prefix ‘name:’ convention. |
| groupby_filter | /Pages/groupby_filter(java:filter=tags has ‘java’, | Group results by matching filters. |
| | javascript:filter=tags | Optionally, names of each filter |
| | has ‘javascript’) | results are |
| | | assigned by the prefix ‘name:’ |
| | | convention. |
| groupby_georange | /Tweets/groupby_georange(field=‘location’, | Group results by geo location |
| | origin=‘lat,lon’, unit=‘km’, | distance range |
| | near:range=(,10), far:range=(50,)) | from a specified point of origin |
| | | Optionally, names of each filter |
| | | results are |
| | | assigned by the prefix ‘name:’ |
| | | convention. |

In some embodiments, the functions include metric functions that aggregate functions to compute an aggregate function on the result set and return a value. Exemplary metric functions are illustrated in Table 4.

TABLE 4

| Function Name | Syntax | Description |
|---|---|---|
| min | /Tweets/min(field=‘comment_count’) | Min of comment_count |
| max | /Tweets/max(field=‘comment_count’) | Max of comment_count |
| avg | /Tweets/avg(field=‘comment_count’) | Average of comment_count |
| sum | /Tweets/sum(field=‘comment_count’) | Sum of comment_count |
| ext_stats | /Tweets/ext_stats(field=‘comment_count’) | Extended statistics on comment_count |
| | | (min, max, avg, sum, mean . . . ) |
| stats | /Tweets/stats(field=‘comment_count’) | Basic Statistics on comment_count (min, |
| | | max, avg, sum) |

In some embodiments, the functions include nested functions that enable functions to be nested such that a second function can be executed on the results of a previous function. An exemplary nested function is illustrated in Table 5.

TABLE 5

| Example URL | Description |
|---|---|
| GET | Here an aggregation of group by “retweets” value and a sub- |
| /tweets/groupby_value(field=‘retweets’)/avg(field=‘age’) | aggregation to get |
| | average of “age” in each group by value of “retweets”. |

Conversion component 112 receives the REST query that may utilize any of the operations or functions illustrated in Tables 1-5, and based on the target or targets of the query (e.g., target 106), translates the query into appropriate format in accordance with the target or targets of the query. For example, if a portion of the query seeks data from a SQL database, the conversion component 112 converts that portion of the query to a SQL structured query. Similarly, if a portion of the query seeks data from a NoSQL database, the conversion component 112 converts that portion of the query to a NoSQL structured query. To do so, the conversion component 112 may identify the target or targets of the query and identify a format of the target or targets of the query.

Once the format of the target or targets of the query is identified, the conversion component 112 may map the portion of the query to the query paradigm corresponding to the identity. In other words, the conversion component 112 converts the syntax of the query into a query (i.e., the backend query) that corresponds to the syntax of the target or target of the query (e.g., SQL, NoSQL, and the like). The backend query may normalize the function tree into a normalized tree in accordance with a structure of a target or targets of the query. In other words, the REST query is translated into a tree structure of the appropriate query language for a target or target of the query. This is implemented by recursively parsing the input query tree and translating each function into an equivalent target function or operator based in the backend technologies and applying the function parameters to each target function as arguments.

Communication component 114 communicates the backend query back to REST API 104 so the backend query can be issued against the target 106. As can be appreciated, communication component 114 may communicate multiple backend queries to REST API 104 if more than one target is subject to the REST query.

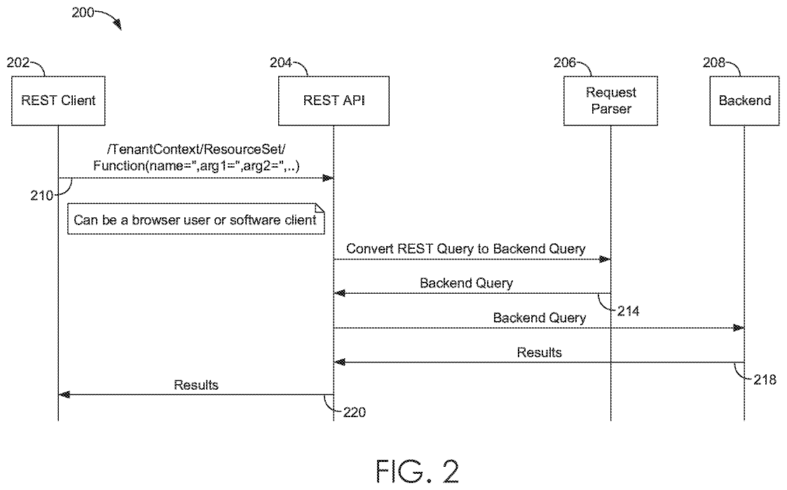

In practice, and as shown in FIG. 2, a block diagram 200 illustrates a flow of communication between components of an exemplary query system, in accordance with embodiments of the present disclosure. As illustrated, a user may communicate a REST query URI 210 to a REST API 204 via a REST client 202 or a HTTP client. The REST query URI 210 comprises a syntax of functions with named parameters as URI path segments over a HTTP GET call and forming a function tree. REST API 204 communicates the REST query URI 210 to request parser 206 so the REST query URI 210 can be converted to a backend query 214. REST API 204 can then issue the backend query 214 to the backend database 208. As described, the REST query URI 210 may be converted into multiple backend queries that seek data from multiple backend databases. Once the backend query 214 is issued by REST API 204, results 218 are received by REST API 204 from the backend database 208 and provided to the user via REST client 202.

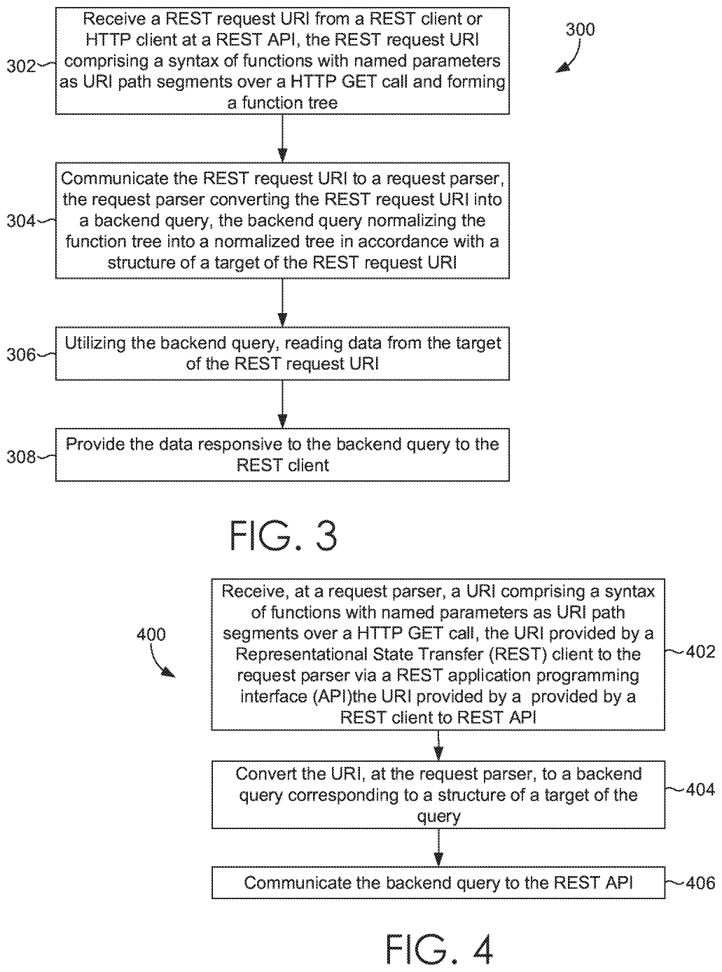

In FIG. 3, a flow diagram is provided that illustrates a method 300 of providing data responsive to a converted REST request URI, in accordance with embodiments of the present disclosure. For instance, the method 300 may be employed utilizing the query system 100 of FIG. 1. As described above and as shown at step 302, a Representational State Transfer (REST) query Uniform Resource Identifier (URI) is received from a REST client or a Hypertext Transfer Protocol (HTTP) client at a REST application programming interface (API). The REST request URI comprises a syntax of functions with named parameters as URI path segments over a HTTP GET call and forming a function tree.

In some embodiments, the REST request URI comprises chained or nested functions. In some embodiments, the REST request URI seeks data from a plurality of targets. In this way, the REST request URI aggregates data from a plurality of targets. In some embodiments, the plurality of targets is one or more of: a database management system, a database, a distributed storage and processing platform, or a search engine. Additionally or alternatively, at least one of the plurality of targets may have a different structure than another of the plurality of targets.

In some embodiments, it is determined, at the REST API, if a user submitting the REST request URI has access to at least a portion of the target responsive to the REST request URI. In one embodiment, upon determining the user submitting the REST request URI does not have access to at least a portion of the target responsive to the REST request URI, the REST request URI is denied for the portion of the target. Alternatively, upon determining the user submitting the REST request URI has access to at least a portion of the target responsive to the REST request URI, the REST request URI is permitted for the portion of the target. In this way, security can be enforced based on access to the URI path segments that are part of the query.

At step 304, the REST request URI is communicated to a request parser. The request parser converts the REST request URI into a backend query. The backend query normalizes the function tree into a normalized tree in accordance with a structure of a target of the REST request URI.

The REST API may receive the backend query from the request parser. At step 306, the backend query is utilized to query data from the target of the REST request URI.

At step 308, the data responsive to the backend query is provided to the REST client or the HTTP client via the REST API. The data may be provided to the REST client in a JavaScript Object Notation (JSON) format, Extensible Markup Language (XML) format, or YAML Ain't Markup Language (YAML) format. In some embodiments, the data is grouped in accordance with the REST request URI based on one or more of: a value, a time interval, a numeric range, a geographic range, or a filter criteria.

Additionally or alternatively, the data is grouped in accordance with the REST request URI based on classification generated by one or more machine learning algorithms, such as linear regression or k-means clustering, to name a few (e.g., group the tweets based on user identification and show the top 10 based on descending order of number of likes: /ca/tweets/groupby_value(field=‘userId’,top=10,orderby=‘likes desc’), group the tweets based on distance of the geographic location of the tweet based on its distance from a given origin point: /ca/tweets/groupby_georange(field=‘location’, origin=‘−10.20,20.10’, range:close=(0, 10), range:far=(10,100), units=‘miles’), group the tweets based on user identification and sub group tweets per day: /catweets/groupby_value(field=‘userId’)/groupby_timeinterval(field=‘timestamp’, interval=‘day’)?_top=100, group tweets based on user identification and show the average minimum and maximum number of likes in each group: /ca/tweets/groupby_value(field=‘userId’)/avg(field=‘likes’),min(field=‘likes’),max(field=‘likes’) group tweets based on year, month in each year, and then day in each month: /ca/tweets/groupby_timeinterval(field=‘timestamp’,interval=‘year’)/groupby_timeinterval(field=‘timestamp’,interval=‘month’)/groupby_timeinterval(field=‘timestamp’,interval=‘day’), group tweets by city and then cluster the results based on KMeans algorithm: /ca/tweets/groupby_value(field=‘city’)/kmeans_clustering(clusters=5,iterations=10), group tweets based on city and cluster the tweets into two using Gaussian mixture: /ca/tweets/groupby_value(field=‘city’)/guassian_mixture(k=2)).

Referring to FIG. 4, a flow diagram is provided that illustrates a method 400 of converting a REST request URI into a backend query, in accordance with embodiments of the present disclosure. For instance, the method 400 may be employed utilizing the query system 100 of FIG. 1. As described above and as shown at step 402, a Uniform Resource Identifier (URI) is received at a request parser. The URI comprises a syntax of functions with named parameters as URI path segments over a Hypertext Transfer Protocol (HTTP) GET call. The URI may be provided by a REST client or a HTTP client to the request parser via a REST API.

At step 404, the URI is converted, at the request parser, to a backend query corresponding to a structure of a target of the query. The target of the URI may comprise more than database. In embodiments, at least one of the databases of the more than one database is in a different format than at least another of the databases of the more than one database.

At step 406, the backend query is communicated to the REST API. The REST API may issue the backend query to the target of the URI. Data responsive to the backend query may be provided to the REST API from the target of the query. The REST API may communicate the data responsive to the backend query to the REST client.

Having described embodiments of the present disclosure, an exemplary operating environment in which embodiments of the present disclosure may be implemented is described below in order to provide a general context for various aspects of the present disclosure. Referring to FIG. 5 in particular, an exemplary operating environment for implementing embodiments of the present disclosure is shown and designated generally as computing device 500. Computing device 500 is but one example of a suitable computing environment and is not intended to suggest any limitation as to the scope of use or functionality of the inventive embodiments. Neither should the computing device 500 be interpreted as having any dependency or requirement relating to any one or combination of components illustrated.

The inventive embodiments may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The inventive embodiments may be practiced in a variety of system configurations, including handheld devices, consumer electronics, general-purpose computers, more specialty computing devices, etc. The inventive embodiments may also be practiced in distributed computing environments where tasks are performed by remote-processing devices that are linked through a communications network.

With reference to FIG. 5, computing device 500 includes a bus 510 that directly or indirectly couples the following devices: memory 512, one or more processors 514, one or more presentation components 516, input/output (I/O) ports 518, input/output (I/O) components 520, and an illustrative power supply 522. Bus 510 represents what may be one or more busses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 5 is merely illustrative of an exemplary computing device that can be used in connection with one or more embodiments of the present disclosure. Distinction is not made between such categories as “workstation,” “server,” “laptop,” “handheld device,” etc., as all are contemplated within the scope of FIG. 5 and reference to “computing device.”

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 500. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 512 includes computer-storage media in the form of volatile and/or nonvolatile memory. The memory may be removable, non-removable, or a combination thereof. Exemplary hardware devices include solid-state memory, hard drives, optical-disc drives, etc. Computing device 500 includes one or more processors that read data from various entities such as memory 512 or I/O components 520. Presentation component(s) 516 present data indications to a user or other device. Exemplary presentation components include a display device, speaker, printing component, vibrating component, etc.

I/O ports 518 allow computing device 500 to be logically coupled to other devices including I/O components 520, some of which may be built in. Illustrative components include a microphone, joystick, game pad, satellite dish, scanner, printer, wireless device, etc. The I/O components 520 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 500. The computing device 500 may be equipped with depth cameras, such as stereoscopic camera systems, infrared camera systems, RGB camera systems, and combinations of these, for gesture detection and recognition. Additionally, the computing device 500 may be equipped with accelerometers or gyroscopes that enable detection of motion. The output of the accelerometers or gyroscopes may be provided to the display of the computing device 500 to render immersive augmented reality or virtual reality.

As can be understood, embodiments of the present disclosure provide for an objective approach for providing REST API paradigms for big data analytics. The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method comprising:
receiving a Representational State Transfer (REST) request Uniform Resource Identifier (URI) from a REST client or a Hypertext Transfer Protocol (HTTP) client at a REST application programming interface (API), the REST request URI comprising a syntax of functions with named parameters as URI path segments over a HTTP GET call and forming a function tree;
communicating the REST request URI to a request parser, the request parser converting the REST request URI into a backend query, the backend query normalizing the function tree into a normalized tree in accordance with a structure of a target of the REST request URI;
utilizing the backend query, querying data from the target of the REST request URI; and
providing the data responsive to the backend query to the REST client or the HTTP client.

2. The method of claim 1, wherein the REST request URI comprises chained or nested functions.

3. The method of claim 1, wherein the REST request URI aggregates data from a plurality of targets.

4. The method of claim 3, wherein the plurality of targets is one or more of: a database management system, a database, a distributed storage and processing platform, or a search engine.

5. The method of claim 3, wherein at least one of the plurality of targets has a different structure than another of the plurality of targets.

6. The method of claim 1, further comprising grouping the data in accordance with the REST request URI based on one or more of: a value, a time interval, a numeric range, a geographic range, or a filter criteria.

7. The method of claim 1, further comprising grouping the data in accordance with the REST request URI based on one or more machine learning algorithms.

8. The method of claim 8, wherein the one or more machine learning algorithms comprise linear regression or k-means clustering.

9. The method of claim 1, wherein the data is provided to the REST client in a JavaScript Object Notation (JSON) format, Extensible Markup Language (XML) format, or YAML Ain't Markup Language (YAML) format.

10. The method of claim 1, further comprising, determining, at the REST API, if a user submitting the REST request URI has access to at least a portion of the target responsive to the REST request URI.

11. The method of claim 11, further comprising, upon determining the user submitting the REST request URI does not have access to at least a portion of the target responsive to the REST request URI, denying the REST request URI for the portion of the target.

12. The method of claim 11, further comprising, upon determining the user submitting the REST request URI has access to at least a portion of the target responsive to the REST request URI, permitting the REST request URI for the portion of the target.

13. The method of claim 1, further comprising, receiving, at the REST API, the backend query from the request parser.

14. A computer storage medium storing computer-useable instructions that, when used by at least one computing device, cause the at least one computing device to perform operations comprising:
receiving, at a request parser, a Uniform Resource Identifier (URI) comprising a syntax of functions with named parameters as URI path segments over a Hypertext Transfer Protocol (HTTP) GET call, the URI provided by a Representational State Transfer (REST) client or a HTTP client to the request parser via a REST application programming interface (API);
converting the URI, at the request parser, to a backend query corresponding to a structure of a target of the query; and
communicating the backend query to the REST API.

15. The computer storage medium of claim 14, wherein the REST API issues the backend query to the target of the URI.

16. The computer storage medium of claim 14, wherein data responsive to the backend query is provided to the REST API from the target of the query.

17. The computer storage medium of claim 14, wherein the REST API communicates the data responsive to the backend query to the REST client.

18. The computer storage medium of claim 14, wherein the target of the URI comprises more than database.

19. The computer storage medium of claim 14, wherein at least one of the databases of the more than one database is in a different format than at least another of the databases of the more than one database.

20. A computerized system comprising:
a processor; and
a computer storage medium storing computer-useable instructions that, when used by the processor, cause the processor to:
receive, at a request parser, a request comprising a syntax of functions with named parameters as path segments over a Hypertext Transfer Protocol (HTTP) GET call provided by a representational state transfer (REST) client or a HTTP client to the request parser via a REST application programming interface (API);
convert the request at the request parser to a backend query corresponding to a structure of a target of the query, the target of the request comprising more than one database, wherein a first database of the more than one database is in a different format than a second database of the more than one database; and
communicate the backend query to the REST API.
